(19) United States
(12) Patent Application Publication
(10) Pub. No.: US 2015/0201449 A1
(43) Pub. Date: Jul. 16, 2015

(54) OPERATING METHOD BASED ON AUTONOMOUS DENIAL PATTERN CONFIGURATION IN WIRELESS COMMUNICATION SYSTEM, AND APPARATUS FOR SUPPORTING SAME

(71) Applicant: LG ELECTRONICS INC., Seoul (KR)

(72) Inventors: Sunghoon Jung, Anyang-si (KR); Youngdae Lee, Anyang-si (KR); Sungjun Park, Anyang-si (KR); Seungjune Yi, Anyang-si (KR); Jaewook Lee, Anyang-si (KR)

(73) Assignee: LG ELECTRONICS INC., Seoul (KR)

(21) Appl. No.: 14/409,963

(22) PCT Filed: Jun. 21, 2013
(86) PCT No.: PCT/KR2013/005502

§ 371 Date: Dec. 19, 2014

Related U.S. Application Data
(60) Provisional application No. 61/662,899, filed on Jun. 21, 2012.

(51) Int. Cl. H04W 76/02; H04W 72/08

(52) U.S. Cl. CPC H04W 76/027; H04W 72/082

(57) ABSTRACT

Provided is an autonomous denial pattern-based operating method to be performed by a terminal in a wireless communication system. The method comprises: acquiring an autonomous denial pattern configuration from a network, wherein the autonomous denial pattern configuration includes autonomous denial pattern period indication information and type indication information; and performing an autonomous denial operation based on the autonomous denial pattern. The autonomous denial pattern period indication information indicates the length of the autonomous denial pattern of one period. The type indication information identifies the type of each subframe in the autonomous denial pattern of said one period.

### BACKGROUND OF THE INVENTION

1. Field of the invention

The present invention relates to wireless communication and, more particularly, to an operation method based on an autonomous denial pattern configuration in a wireless communication system, and an apparatus for supporting the same.

2. Related Art

3rd generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

A terminal may automatically limit transmission/reception to be operated for a specific sub-frame, which refers to an autonomous denial. The autonomous denial is applicable according to in-device coexistence (IDC) interference due to coexistence of an LTE module and a module of an industry-science-medical (ISM) band. A frequency band used for communication through the LTE module overlaps with a frequency band use for communication through the ISM band to cause interference. In order to prevent this, the terminal moves a frequency to a licensed band instead of the ISM band to be operated or may not perform uplink communication at a specific sub-frame. Not to perform the uplink communication at the specific sub-frame refers to an autonomous denial operation.

The terminal operated by applying the autonomous denial may determine whether to apply the autonomous denial to each sub-frame. Meanwhile, the network cannot know that the autonomous denial is applied to a certain sub-frame by the terminal. In this state, a resource for uplink communication may be scheduled. Although the network allocates an uplink communication resource, the terminal disregards a specific sub-frame without using the sub-frame. This may consume an allocated resource.

### SUMMARY OF THE INVENTION

The present invention provides an operation method based on an autonomous denial pattern configuration in a wireless communication system, and an apparatus for supporting the same.

In an aspect, there is provided an operation method based on an autonomous denial pattern configuration by a terminal in a wireless communication system. The method comprises acquiring an autonomous denial pattern configuration form a network, wherein the autonomous denial pattern configuration includes autonomous denial pattern period indication information and type indication information, performing an autonomous denial pattern operation based on the autonomous denial pattern, wherein the autonomous denial pattern period indication information indicates a length of the autonomous denial pattern of one period, and the type indication information identifies the type of each sub-frame in the autonomous denial pattern of the one period.

The performing of the autonomous denial pattern operation may comprise identifying a type of the sub-frame based on the type indication information, operating the terminal by applying an autonomous denial to the sub-frame when the type of the sub-frame is a first type and operating the terminal without applying the autonomous denial to the sub-frame when the type of the sub-frame is a second type.

The operating the terminal without applying the autonomous denial to the sub-frame may comprise using the sub-frame for uplink transmission.

The operating the terminal by applying an autonomous denial to the sub-frame may comprise determining whether to use the sub-frame for the uplink transmission based on the autonomous denial pattern.

The operating the terminal by applying an autonomous denial to the sub-frame may not use the sub-frame for uplink transmission.

The autonomous denial pattern configuration may comprise valid interval indication information and the valid interval indication information indicates a valid interval of the autonomous denial pattern. The method may further comprise stopping the autonomous denial operation when the interval indicated by the valid interval indication information elapses from acquisition of the autonomous denial pattern configuration.

The autonomous denial pattern configuration may indicate the number of repeated applications of the autonomous denial pattern.

The method may further comprise transmitting a report message indicating the autonomous denial operation stop report to the network when the autonomous denial operation stops.

The autonomous denial pattern configuration may comprise information indicating the maximum number of the autonomous denial sub-frame. The method may further comprise stopping the autonomous denial operation when the sub-frame is denied from a use of uplink communication by the indicated maximum number during the autonomous denial operation.

The method may further comprise sensing in-device coexistence (IDC) interference; and transmitting an IDC indicator indicating the sensing to the network, wherein the autonomous denial pattern configuration is transmitted as a response to the IDC indicator.

The method may further comprise sensing in-device coexistence (IDC) interference; and transmitting an IDC indicator indicating the sensing to the network, wherein the performing of the autonomous denial operation is performed corresponding to the IDC interference.

The method may further comprise receiving an IDC configuration which is configuration information associated with transmission of the IDC indicator from the network, wherein the IDC configuration and the autonomous denial pattern configuration are simultaneously transmitted through a radio resource control (RRC) message.

The method may further comprise transmitting UE assistance information to the network, wherein the UE assistance information comprises information on a desired autonomous denial pattern from the terminal.

The autonomous denial pattern configuration may be generated based on information on the desired autonomous denial pattern transmitted from the terminal.

In another aspect, there is provided a wireless apparatus operating in a wireless communication system. The wireless apparatus comprises a Radio Frequency (RF) unit that sends and receives radio signals and a processor that is functionally coupled to the RF unit and operates, wherein the processor is configured to: acquire an autonomous denial pattern configuration form a network, wherein the autonomous denial pattern configuration includes autonomous denial pattern period indication information and type indication information; perform an autonomous denial pattern operation based on the autonomous denial pattern, wherein the autonomous denial pattern period indication information indicates a length of the autonomous denial pattern of one period, and the type indication information identifies the type of each sub-frame in the autonomous denial pattern of the one period.

According to the operation method of the present invention, the network may configure an autonomous denial pattern in the terminal. Through information included in a designated denial pattern configuration, the network may designate a sub-frame to which the autonomous denial is applied or not applied by the terminal. Accordingly, the terminal is operated not to apply the autonomous denial to a specific sub-frame or to apply the autonomous denial to the specific sub-frame to determine whether or not to use a corresponding sub-frame. Since the network may ensure uplink communication by a terminal for a designated sub-frame, a radio resource scheduled by the network may be prevented from being consumed. In addition, since the network may configure a valid interval of the autonomous denial pattern, the terminal may be prevented from being excessively operated based on the autonomous denial pattern.

### BRIEF DESCRIPTION OF THE DRAWINGS

FIG. 1 illustrates a wireless communication system to which the present invention is applied.

FIG. 2 is a block diagram showing the structure of a wireless protocol on the user plane.

FIG. 3 is a block diagram showing the structure of a wireless protocol on the control plane.

FIG. 4 is a flowchart illustrating the operation of UE in the RRC idle state.

FIG. 5 is a flowchart illustrating a process of establishing RRC connection.

FIG. 6 is a flowchart illustrating an RRC connection reconfiguration process.

FIG. 7 is a diagram illustrating an RRC connection re-establishment procedure.

FIG. 8 illustrates a situation where LTE, GPS, and BT/Wi-Fi may interfere with each other in a coexisting IDC environment in one terminal.

FIG. 9 is a flowchart illustrating an operation method based on an autonomous denial pattern configuration according to an embodiment of the present invention.

FIG. 10 is a flowchart illustrating an operation method based on an autonomous denial pattern configuration according to another embodiment of the present invention.

FIG. 11 is a diagram illustrating an example of an operation of a terminal based on an autonomous denial pattern configuration according to an embodiment of the present invention.

FIG. 12 is a block diagram illustrating a wireless apparatus according to an embodiment of the present invention.

### DESCRIPTION OF EXEMPLARY EMBODIMENTS

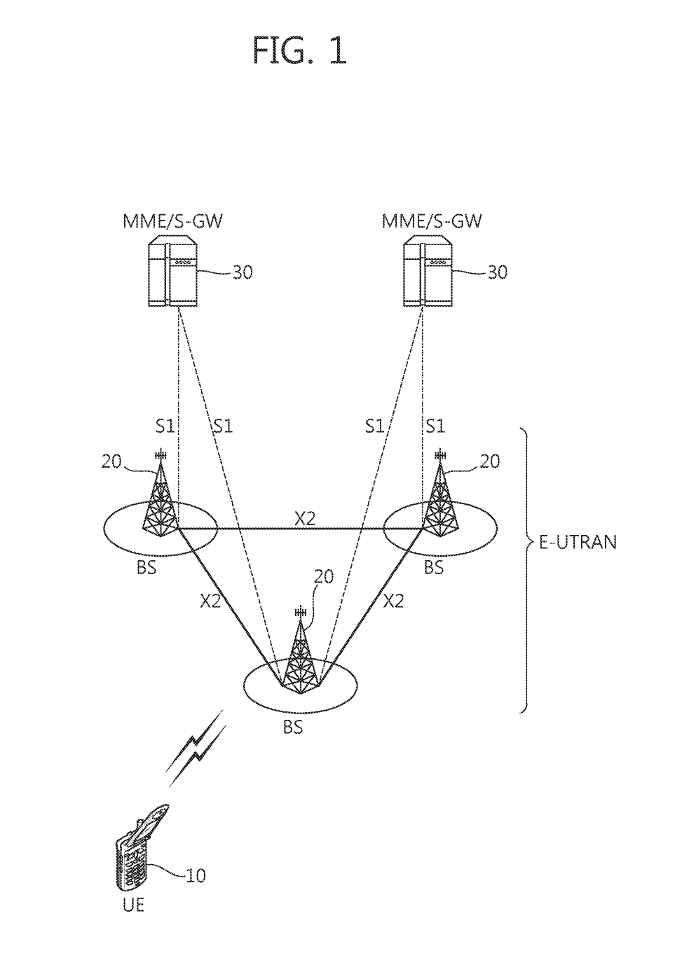

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an Si interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

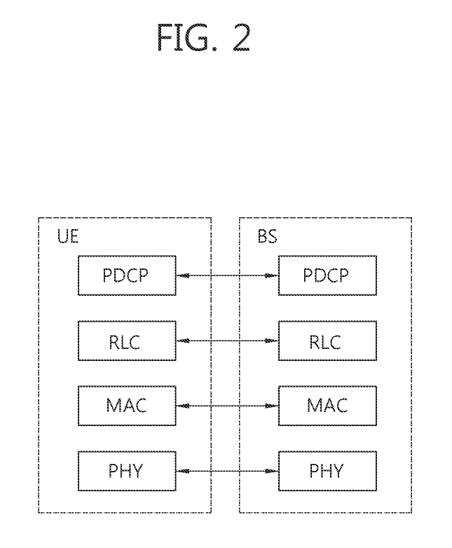

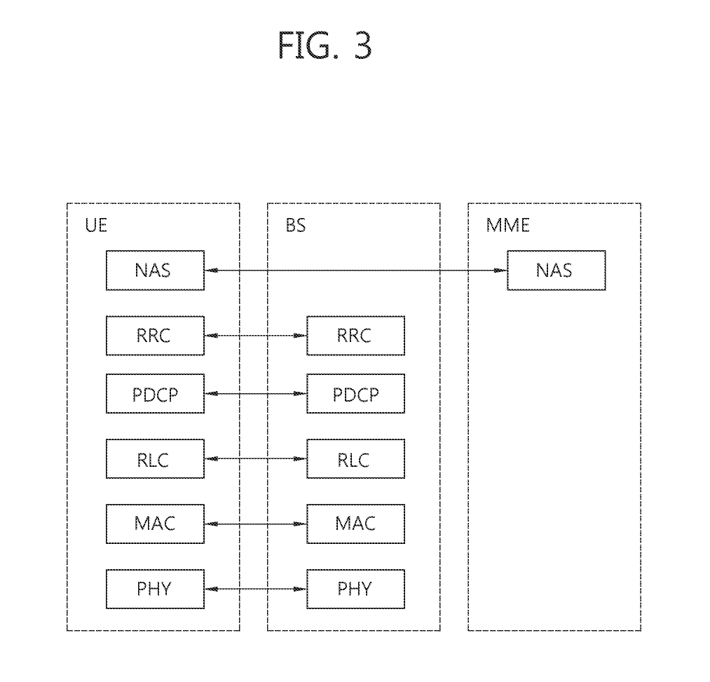

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a process of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes 51 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

System information is described below.

System information includes essential information that needs to be known by UE in order for the UE to access a BS. Accordingly, the UE needs to have received all pieces of system information before accessing the BS, and needs to always have the up-to-date system information. Furthermore, the BS periodically transmits the system information because the system information is information that needs to be known by all UEs within one cell.

In accordance with Paragraph 5.2.2 of 3GPP TS 36.331 V8.7.0 (2009-09) “Radio Resource Control (RRC); Protocol specification (Release 8)”, the system information is classified into a Master Information Block (MIB), a Scheduling Block (SB), and a System Information Block (SIB). The MIB informs UE of the physical configuration of a corresponding cell, for example, a bandwidth. The SB informs UE of information about the transmission of SIBs, for example, a transmission cycle. The SIB is a set of pieces of correlated system information. For example, a specific SIB includes only information about surrounding cells, and a specific SIB includes only information about an uplink radio channel used by UE.

In general, service that is provided to UE by a network may be classified into three types as follows. Furthermore, the UE differently recognizes the type of cell depending on what service may be provided to the UE. In the following description, a service type is first described, and the type of cell is described.

1) Limited service: this service provides emergency calls and an Earthquake and Tsunami Warning System (ETWS), and may be provided by an acceptable cell.

2) Suitable service: this service means public service for common uses, and may be provided by a suitable cell (or a normal cell).

3) Operator service: this service means service for communication network operators. This cell may be used by only communication network operators, but may not be used by common users.

In relation to a service type provided by a cell, the type of cell may be classified as follows.

1) An acceptable cell: this cell is a cell from which UE may be provided with limited service. This cell is a cell that has not been barred from a viewpoint of corresponding UE and that satisfies the cell selection criterion of the UE.

2) A suitable cell: this cell is a cell from which UE may be provided with suitable service. This cell satisfies the conditions of an acceptable cell and also satisfies additional conditions. The additional conditions include that the suitable cell needs to belong to a Public Land Mobile Network (PLMN) to which corresponding UE may access and that the suitable cell is a cell on which the execution of a tracking area update procedure by the UE is not barred. If a corresponding cell is a CSG cell, the cell needs to be a cell to which UE may access as a member of the CSG.

3) A barred cell: this cell is a cell that broadcasts information indicative of a barred cell through system information.

4) A reserved cell: this cell is a cell that broadcasts information indicative of a reserved cell through system information.

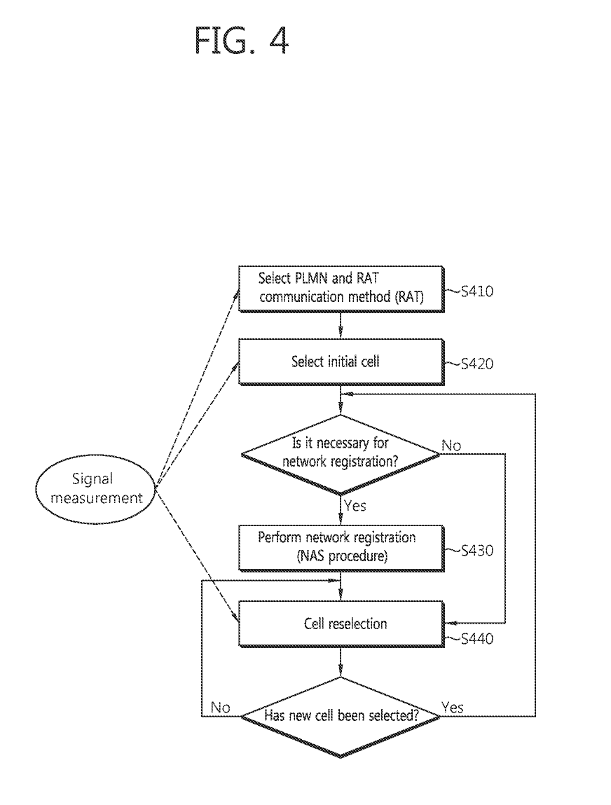

FIG. 4 is a flowchart illustrating the operation of UE in the RRC idle state. FIG. 4 illustrates a procedure in which UE that is initially powered on experiences a cell selection process, registers it with a network, and then performs cell reselection if necessary.

Referring to FIG. 4, the UE selects Radio Access Technology (RAT) in which the UE communicates with a Public Land Mobile Network (PLMN), that is, a network from which the UE is provided with service (S410). Information about the PLMN and the RAT may be selected by the user of the UE, and the information stored in a Universal Subscriber Identity Module (USIM) may be used.

The UE selects a cell that has the greatest value and that belongs to cells having measured BS and signal intensity or quality greater than a specific value (cell selection) (S420). In this case, the UE that is powered off performs cell selection, which may be called initial cell selection. A cell selection procedure is described later in detail. After the cell selection, the UE receives system information periodically by the BS. The specific value refers to a value that is defined in a system in order for the quality of a physical signal in data transmission/reception to be guaranteed. Accordingly, the specific value may differ depending on applied RAT.

If network registration is necessary, the UE performs a network registration procedure (S430). The UE registers its information (e.g., an IMSI) with the network in order to receive service (e.g., paging) from the network. The UE does not register it with a network whenever it selects a cell, but registers it with a network when information about the network (e.g., a Tracking Area Identity (TAI)) included in system information is different from information about the network that is known to the UE.

The UE performs cell reselection based on a service environment provided by the cell or the environment of the UE (S440). If the value of the intensity or quality of a signal measured based on a BS from which the UE is provided with service is lower than that measured based on a BS of a neighboring cell, the UE selects a cell that belongs to other cells and that provides better signal characteristics than the cell of the BS that is accessed by the UE. This process is called cell reselection differently from the initial cell selection of the No. 2 process. In this case, temporal restriction conditions are placed in order for a cell to be frequently reselected in response to a change of signal characteristic. A cell reselection procedure is described later in detail.

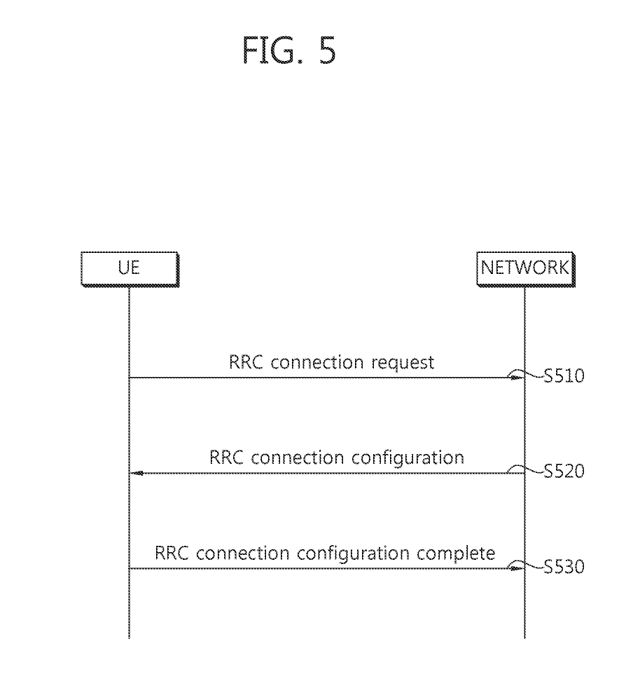

FIG. 5 is a flowchart illustrating a process of establishing RRC connection.

UE sends an RRC connection request message that requests RRC connection to a network (S510). The network sends an RRC connection establishment message as a response to the RRC connection request (S520). After receiving the RRC connection establishment message, the UE enters RRC connected mode.

The UE sends an RRC connection establishment complete message used to check the successful completion of the RRC connection to the network (S530).

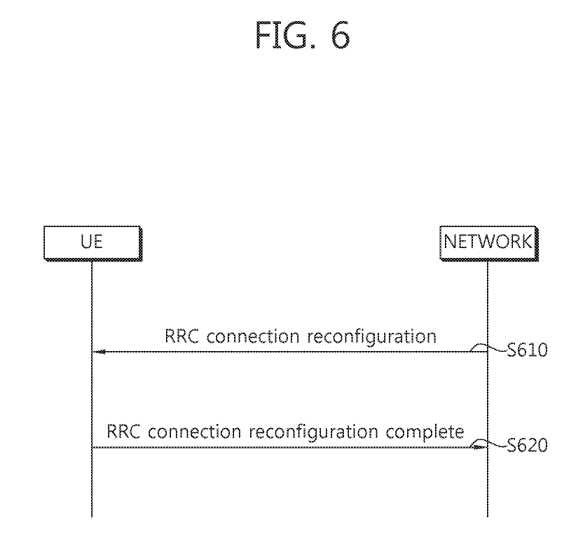

FIG. 6 is a flowchart illustrating an RRC connection reconfiguration process. An RRC connection reconfiguration is used to modify RRC connection. This is used to establish/modify/release RBs, perform handover, and set up/modify/release measurements.

A network sends an RRC connection reconfiguration message for modifying RRC connection to UE (S610). As a response to the RRC connection reconfiguration message, the UE sends an RRC connection reconfiguration complete message used to check the successful completion of the RRC connection reconfiguration to the network (S620).

Hereinafter, a public land mobile network (PLMN) is described.

The PLMN is a network which is disposed and operated by a mobile network operator. Each mobile network operator operates one or more PLMNs. Each PLMN may be identified by a Mobile Country Code (MCC) and a Mobile Network Code (MNC). PLMN information of a cell is included in system information and broadcasted.

In PLMN selection, cell selection, and cell reselection, various types of PLMNs may be considered by the terminal.

Home PLMN (HPLMN): PLMN having MCC and MNC matching with MCC and MNC of a terminal IMSI.

Equivalent HPLMN (EHPLMN): PLMN serving as an equivalent of an HPLMN.

Registered PLMN (RPLMN): PLMN successfully finishing location registration.

Equivalent PLMN (EPLMN): PLMN serving as an equivalent of an RPLMN.

Each mobile service consumer subscribes in the HPLMN. When a general service is provided to the terminal through the HPLMN or the EHPLMN, the terminal is not in a roaming state. Meanwhile, when the service is provided to the terminal through a PLMN except for the HPLMN/EHPLMN, the terminal is in the roaming state. In this case, the PLMN refers to a Visited PLMN (VPLMN).

When UE is initially powered on, the UE searches for available Public Land Mobile Networks (PLMNs) and selects a proper PLMN from which the UE is able to be provided with service. The PLMN is a network that is deployed or operated by a mobile network operator. Each mobile network operator operates one or more PLMNs. Each PLMN may be identified by Mobile Country Code (MCC) and Mobile Network Code (MNC). Information about the PLMN of a cell is included in system information and broadcasted. The UE attempts to register it with the selected PLMN. If registration is successful, the selected PLMN becomes a Registered PLMN (RPLMN). The network may signalize a PLMN list to the UE. In this case, PLMNs included in the PLMN list may be considered to be PLMNs, such as RPLMNs. The UE registered with the network needs to be able to be always reachable by the network. If the UE is in the ECM-CONNECTED state (identically the RRC connection state), the network recognizes that the UE is being provided with service. If the UE is in the ECM-IDLE state (identically the RRC idle state), however, the situation of the UE is not valid in an eNB, but is stored in the MME. In such a case, only the MME is informed of the location of the UE in the ECM-IDLE state through the granularity of the list of Tracking Areas (TAs). A single TA is identified by a Tracking Area Identity (TAI) formed of the identifier of a PLMN to which the TA belongs and Tracking Area Code (TAC) that uniquely expresses the TA within the PLMN.

Thereafter, the UE selects a cell that belongs to cells provided by the selected PLMN and that has signal quality and characteristics on which the UE is able to be provided with proper service.

The following is a detailed description of a procedure of selecting a cell by a terminal

When power is turned-on or the terminal is located in a cell, the terminal performs procedures for receiving a service by selecting/reselecting a suitable quality cell.

A terminal in an RRC idle state should prepare to receive a service through the cell by always selecting a suitable quality cell. For example, a terminal where power is turned-on just before should select the suitable quality cell to be registered in a network. If the terminal in an RRC connection state enters in an RRC idle state, the terminal should selects a cell for stay in the RRC idle state. In this way, a procedure of selecting a cell satisfying a certain condition by the terminal in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the terminal.

A method and a procedure of selecting a cell by a terminal in a 3GPP LTE is described with reference to 3GPP TS 36.304 V8.5.0 (2009-03) “User Equipment (UE) procedures in idle mode (Release 8)”.

A cell selection process is basically divided into two types.

The first is an initial cell selection process. In this process, UE does not have preliminary information about a wireless channel. Accordingly, the UE searches for all wireless channels in order to find out a proper cell. The UE searches for the strongest cell in each channel. Thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection process. If the UE has only to search for a cell that satisfies the cell selection criterion, the UE selects the corresponding cell. If a suitable cell that satisfies the cell selection criterion is not retrieved though such a process, the UE performs an initial cell selection process.

After the UE selects a specific cell through the cell selection process, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a process is called cell reselection. In general, a basic object of the cell reselection process is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection process compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection process is as follows

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency.

For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection.

For the intra-frequency or inter-frequency cell reselection, a network may provide UE with a cell reselection black list used in cell reselection. The UE does not perform cell reselection on a cell included in the black list.

Ranking performed in a cell reselection evaluation process is described below.

A ranking criterion used to apply priority to a cell is defined as in Equation 1.

Rₛ=Q_{meas,s}+Q_{hyst},Rₙ=Q_{meas,s}−Q_{offset} [Equation 1]

In this case, Rs is the ranking criterion of a serving cell, Rn is the ranking criterion of a neighbor cell, Qmeas,s is the quality value of the serving cell measured by UE, Qmeas,n is the quality value of the neighbor cell measured by UE, Qhyst is the hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell reselection.

Radio Link Monitoring (RLM) is described below.

UE monitors downlink quality based on a cell-specific reference signal in order to detect the quality of the downlink radio link of a PCell. The UE estimates the quality of a downlink radio link in order to monitor the quality of the downlink radio link of the PCell, and compares the estimated quality with threshold values Qout and Qin. The threshold value Qout is defined as a level at which a downlink radio link is unable to be stably received, which corresponds to a block error rate of 10% of hypothetical PDCCH transmission by taking into consideration a PDFICH error. The threshold value Qin is defined as a downlink radio link quality level at which a downlink radio link is able to be more stably received than compared to the level of Qout, which corresponds to a block error rate of 2% of hypothetical PDCCH transmission by taking into consideration a PDFICH error.

A Radio Link Failure (RLF) is described below.

UE continues to perform measurements in order to maintain the quality of a radio link with a serving cell from which the UE receives service. The UE determines whether or not communication is impossible in a current situation due to the deterioration of the quality of the radio link with the serving cell. If communication is almost impossible because the quality of the serving cell is too low, the UE determines the current situation to be an RLF.

If the RLF is determined, the UE abandons maintaining communication with the current serving cell, selects a new cell through cell selection (or cell reselection) procedure, and attempts RRC connection re-establishment with the new cell.

In the specification of 3GPP LTE, the following examples are taken as cases where normal communication is impossible.
A case where UE determines that there is a serious problem in the quality of a downlink communication link (a case where the quality of a PCell is determined to be low while performing RLM) based on the radio quality measured results of the PHY layer of the UE
A case where uplink transmission is problematic because a random access procedure continues to fail in the MAC sublayer.
A case where uplink transmission is problematic because uplink data transmission continues to fail in the RLC sublayer.
A case where handover is determined to have failed.
A case where a message received by UE does not pass through an integrity check.

An RRC connection re-establishment procedure is described in more detail below.

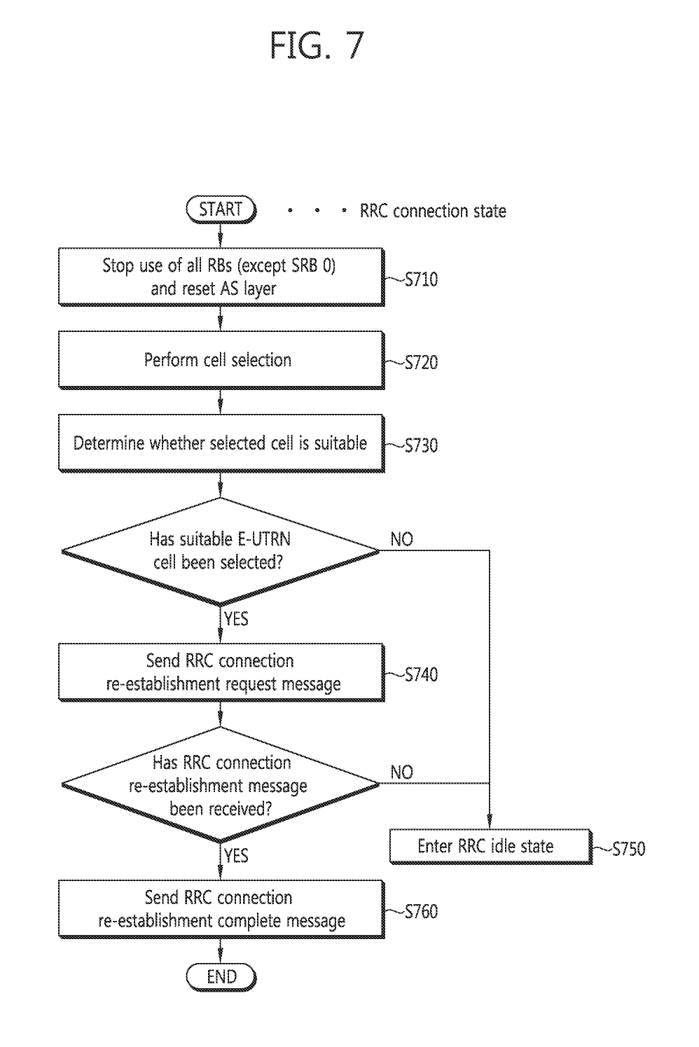

FIG. 7 is a diagram illustrating an RRC connection re-establishment procedure.

Referring to FIG. 7, UE stops using all the radio bearers that have been configured other than a Signaling Radio Bearer (SRB) #0, and initializes a variety of kinds of sublayers of an Access Stratum (AS) (S710). Furthermore, the UE configures each sublayer and the PHY layer as a default configuration. In this process, the UE maintains the RRC connection state.

The UE performs a cell selection procedure for performing an RRC connection reconfiguration procedure (S720). The cell selection procedure of the RRC connection re-establishment procedure may be performed in the same manner as the cell selection procedure that is performed by the UE in the RRC idle state, although the UE maintains the RRC connection state.

After performing the cell selection procedure, the UE determines whether or not a corresponding cell is a suitable cell by checking the system information of the corresponding cell (S730). If the selected cell is determined to be a suitable E-UTRAN cell, the UE sends an RRC connection re-establishment request message to the corresponding cell (S740).

Meanwhile, if the selected cell is determined to be a cell that uses RAT different from that of the E-UTRAN through the cell selection procedure for performing the RRC connection re-establishment procedure, the UE stops the RRC connection re-establishment procedure and enters the RRC idle state (S750).

The UE may be implemented to finish checking whether the selected cell is a suitable cell through the cell selection procedure and the reception of the system information of the selected cell. To this end, the UE may drive a timer when the RRC connection re-establishment procedure is started. The timer may be stopped if it is determined that the UE has selected a suitable cell. If the timer expires, the UE may consider that the RRC connection re-establishment procedure has failed, and may enter the RRC idle state. Such a timer is hereinafter called an RLF timer. In LTE spec TS 36.331, a timer named “T311” may be used as an RLF timer. The UE may obtain the set value of the timer from the system information of the serving cell.

If an RRC connection re-establishment request message is received from the UE and the request is accepted, a cell sends an RRC connection re-establishment message to the UE.

The UE that has received the RRC connection re-establishment message from the cell reconfigures a PDCP sublayer and an RLC sublayer with an SRB1. Furthermore, the UE calculates various key values related to security setting, and reconfigures a PDCP sublayer responsible for security as the newly calculated security key values. Accordingly, the SRB 1 between the UE and the cell is open, and the UE and the cell may exchange RRC control messages. The UE completes the restart of the SRB1, and sends an RRC connection re-establishment complete message indicative of that the RRC connection re-establishment procedure has been completed to the cell (S760).

In contrast, if the RRC connection re-establishment request message is received from the UE and the request is not accepted, the cell sends an RRC connection re-establishment reject message to the UE.

If the RRC connection re-establishment procedure is successfully performed, the cell and the UE perform an RRC connection reconfiguration procedure. Accordingly, the UE recovers the state prior to the execution of the RRC connection re-establishment procedure, and the continuity of service is guaranteed to the upmost.

A report on an RLF is described below.

When an RLF occurs or a handover failure occurs, UE reports such a failure event to a network in order to support the Mobility Robustness Optimization (MRO) of the network.

After RRC connection re-establishment, the UE may provide the RLF report to the eNB. Wireless measurement includes in the RLF report may be used for a potential reason of a failure in order to identify coverage problems. Such information may be used to borrow such events as input to other algorithms by excluding the events in MRO evaluation for an intra-LTE mobility connection failure.

If RRC connection re-establishment fails or UE does not perform RRC connection re-establishment, the UE may be connected again in idle mode, and may generate a valid RLF report on an eNB. For such an object, the UE may store information related to the most recent RLF or handover failure, and may inform an LTE cell that an RLF report is valid every RRC connection (re)establishment and handover until the RLF report is fetched by a network or for 48 hours after an RLF or handover failure is detected.

The UE maintains the information for a state shift and a change of RAT, and indicates that the RLF report is valid again after returning back to LTE RAT.

In an RRC connection establishment procedure, the validity of an RLF report means that UE has experienced obstruction, such as a connection failure, and an RLF report attributable to the failure has not yet been transferred to a network. The RLF report from the UE includes the following information.
If the last cell (in the case of an RLF) that has provided service to the UE or the E-CGI of a target for handover has not been known, a PCI and frequency information are used instead.
The E-CGI of a cell at which re-establishment has been attempted.
When initializing the last handover, for example, when a message 7 (an RRC connection reconfiguration) is received by the UE, the E-CGI of a cell that has provided service to the UE.
The time that has elapsed from the initialization of the last handover to a connection failure.
Information indicative of whether the connection failure is attributable to an RLF or a handover failure.
Wireless measurements.
The location of a failure.

The eNB that has received the RLF from the UE may forward the report to an eNB that had provided service to the UE prior to the reported connection failure. Wireless measurements included in the RLF report may be used to identify coverage issues as a potential cause of an RLF. Such information may be used to send events to other algorithm as input again by excluding the events from the MRO evaluation of an intra-LTE mobility connection failure.

Hereinafter, in-device coexistence (IDC) is described.

A user may include a global navigation satellite system (GNSS) receiver as well as a transceiver for a wireless communication system such as LTE, Wi-Fi, and Bluetooth (BT) in one terminal in order to access various networks regardless of time and location. For example, there may be a terminal having LTE and BT modules in order to receive a VoIP service and a multi-media service using a BT device, a terminal having LTE and Wi-Fi modules for traffic division, and a terminal having GNSS and LTE modules in order to additionally acquire location information.

In the above case, a plurality of transceivers is close to an inside of one terminal, intensity of power transmitted from one transmitter may be greater than reception power of another receiver. By using a filter technology or forming an interval at a use frequency, IDC interference between two transceivers may be prevented from being generated. However, when a plurality of wireless communication modules at an adjacent frequency in one terminal, a current filter technology cannot sufficiently remove interference. There is a need to solve the above problem for coexistence of the transceiver for a plurality of wireless communication modules in the terminal from now.

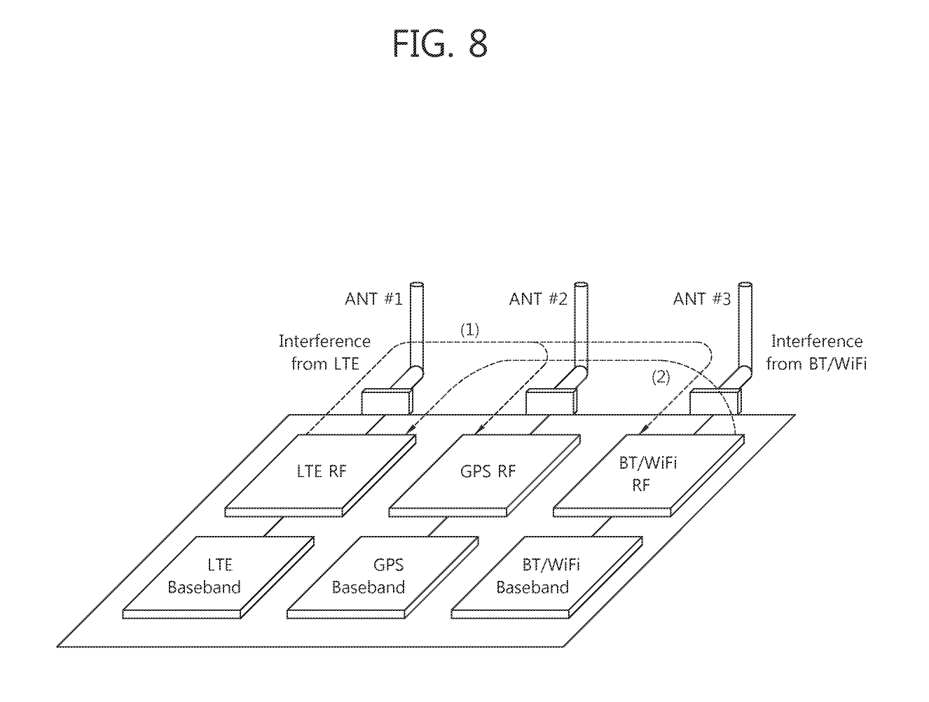

FIG. 8 illustrates a situation where LTE, GPS, and BT/Wi-Fi may interfere with each other in a coexisting IDC environment in one terminal.

IDC interference avoidance is divided into three modes according to presence of coordination with another communication module coexisting with the LTE module and presence of coordination between the LTE module and a base station in order to solve the IDC interference. A first mode is a mode having no coordination in order to avoid IDC interference between coexistence communication modules and between the LTE and the network. In this case, since the LTE module does not know information on another communication module coexisting therewith, lowering of the service quality due to the IDC interference cannot be processed. A second mode is a case where there is coordination between coexisting communication modules inside the terminal. In the second mode, coexisting modules may know on/off state and a traffic transmission state of a module of the other party. The second mode is a mode having no coordination between the terminal and the network. A third mode is a mode having coordination between coexisting modules inside the terminal and coordination between the terminal and the network. In the third mode, the existing modules may know the on/off state and the traffic transmission state and the terminal reports the IDC interference state to the network so that the network determines to avoid the IDC interference to take a corresponding processing.

The LTE module may measure IDC interference through coordination with another module inside the terminal and inter/intra frequency measurement as mentioned above.

The interference may include IDC interference generated when other communication modules coexist to be operated. The IDC interference may be generated in a following coexistence situation.

Interference is generated when the LTE and the Wi-Fi coexist.

The interference is generated when the LTE and the BT coexist.

The interference is generated when the LTE and the GNSS coexist.

Communication modules may interfere with each other by operating at an adjacent frequency in a frequency side as follows.

A LTE TDD operates at Band 40 (2300 MHz˜2400 MHz), and a Wi-Fi and a BT may operate at an unlicensed band (2400 MHz˜2483.5 MHz). In this case, transmission of the LTE may interfere with the Wi-Fi and the BT, and transmission of the Wi-Fi or the BT may interfere with reception of the LTE.

The LTE FDD performs upstream transmission at Band 7 (2500 MHz˜2700 MHz), and the Wi-Fi and the Bluetooth may operate at an unlicensed band (2400 MHz˜2483.5 MHz). In this case, upstream transmission of the LTE may interfere with reception of the Wi-Fi or the Bluetooth.

The LTE FDD may perform upstream transmission at a Band 13 (UL: 777-787 MHz, DL: 746-756 MHz) or a Band 14 (UL: 788-798 MHz, DL: 758-768 MHz), and a GPS radio may receive at 1575.42 MHz. In this case, the upstream transmission of the LTE may interfere with reception of the GPS.

A current 3GPP considers two schemes in order to solve IDC interference. A first scheme is a scheme where a communication module providing interference or a communication module receiving interference changes a frequency. A second scheme is a scheme where a communication module sharing one frequency divides and uses a time (Time Division Multiplexing (TDM)).

If internal interference, that is, IDC interference is sensed between a LTE device and another ISM band device in the terminal, the terminal may transmit IDC indicator to the network. Transmission of the IDC indicator according to sensing of the IDC interference may be triggered due to IDC interference existing on a serving frequency and/or a non-serving frequency without assuming or expecting potential interference. The IDC interference may be sensed when a specific condition is satisfied according to implementation of the terminal or according to the existing measurement result and/or UE internal coordination. The terminal supporting the IDC relation function may report to the network associated therewith. Accordingly, the network may transmit dedicated signaling indicating presence of allow of IDC indicator transmission of the terminal to a corresponding terminal.

The IDC indicator may indicate that the terminal experiences the IDC interference. The IDC indicator may include information on a frequency in which interference is generated and/or information on a time whose use is denied by the terminal. The above information may be based on an operation to avoid IDC interference.

When the IDC indicator is received and the IDC indicator includes information on an interference frequency, the network enables the terminal to move from the interference frequency to another frequency. The above interference avoidance scheme may be a scheme base on FDM. The terminal is inter-frequency moved from a serving frequency according to indication from the network to be operated so that interference with the ISM band may be avoided.

Alternatively, the terminal may avoid interference with an ISM band device by automatically denying uplink communication with respect to a specific sub-frame, which refers to autonomous denial operation. The autonomous denial operation is based on an autonomous denial pattern. The autonomous denial pattern may specify distribution (arrangement) of a sub-frame to be used and a sub-frame not to be used for uplink communication during a specific interval. Meanwhile, in order to limit the number of sub-frames not to be used for uplink communication, a maximum amount of the sub-frame and/or a maximum rate of the sub-frame not to be used during a specific interval may be previously set or may be set from the network. The terminal may form the autonomous denial pattern according to a given condition, and may determine whether to use the sub-frame according to the pattern.

As a result, although the network schedules a wireless resource in the terminal for uplink signaling and/or uplink data transmission, the terminal may be operated by denying use for a specific sub-frame included in the scheduled wireless resource according to the autonomous denial pattern. Since data transmission/reception or signaling is not achieved during a corresponding sub-frame in the above operation scheme, the scheduled wireless resource is consumed.

In order to compensate for the above problem, the present invention provides an operation method in which an autonomous denial pattern configuration is provided by the network. The autonomous denial pattern configuration may include information to specify an autonomous denial pattern which is an autonomous denial operation base of the terminal and/or information to control an autonomous denial pattern based operation configured by the terminal. The terminal may perform an autonomous denial operation based on the autonomous denial pattern configuration acquired from the network.

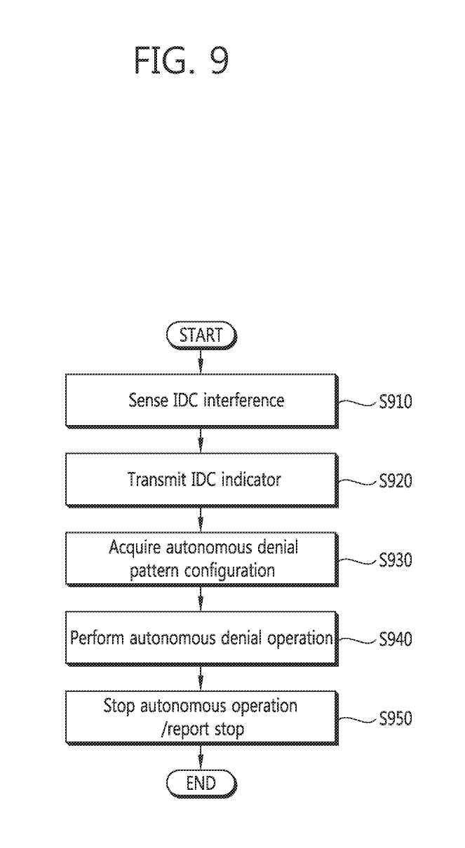

FIG. 9 is a flowchart illustrating an operation method based on an autonomous denial pattern configuration according to an embodiment of the present invention.

Referring to FIG. 9, the terminal senses that IDC interference is generated (S910). When a specific condition according to implementation of the terminal is satisfied, the terminal may sense that the IDC interference is generated. When a specific condition is satisfied according to a measurement result acquired by the terminal and/or UE internal coordination, the terminal may sense that the IDC interference is generated.

When sensing the generation of the IDC interference, the terminal transmits an IDC indicator to the terminal (S920).

The terminal acquires an autonomous denial pattern configuration from the network (S930). The autonomous pattern configuration may include information on the autonomous denial pattern. Hereinafter, one or more information may be included in the autonomous denial pattern configuration.

The autonomous denial pattern configuration may include information indicating a period of the autonomous denial pattern, that is, an interval length of a single autonomous denial pattern. The period of the autonomous denial pattern may be expressed by one of the number of sub-frames, the number of radio frames, and system frame numbers (SFNs), or a combination thereof. It will be understood that the autonomous denial pattern is periodically repeated during a valid interval if the autonomous denial pattern configuration including the information indicating a period of the autonomous denial pattern. The terminal may consider and generate the autonomous denial pattern having a length corresponding to an indicated period.

The autonomous denial pattern configuration may include information indicating a type of each sub frame in the autonomous pattern of one period. Each sub-frame may be classified into a first type sub-frame to which an autonomous denial by the terminal is applied and a second type sub-frame to which the autonomous denial by the terminal is not applied. The terminal may determine whether or not to use a corresponding sub-frame by applying the autonomous denial to a first type of sub-frame. In this case, the terminal may determine whether or not to use the first type of sub-frame or may not use the first type of sub-frame according to an autonomous denial pattern of the terminal. The terminal does not apply an autonomous denial to a second type of sub-frame, and may use a corresponding sub-frame for uplink communication.

The autonomous denial pattern configuration may include an amount of a sub-frame to which the autonomous denial is applicable and/or an amount of a sub-frame to which the autonomous denial is not applied. The network may add information indicating the maximum number of sub-frames to which an autonomous denial is applicable and/or the maximum number of sub-frames to which the autonomous denial is not applied within one autonomous denial pattern period to the autonomous denial pattern configuration to provide the autonomous denial pattern configuration the terminal. Alternatively, the network may add information indicating the maximum number of sub-frames to which an autonomous denial is applicable and/or the maximum number of sub-frames to which the autonomous denial is not applied to the autonomous denial pattern configuration by a valid interval of the autonomous denial pattern to provide the autonomous denial pattern configuration the terminal. When receiving an autonomous denial pattern configuration including information indicating an amount of the autonomous denial sub-frame, the terminal may determine whether an autonomous denial is applied corresponding an amount of a sub-frame indicated during one period of the autonomous denial pattern or a valid interval of the autonomous denial pattern or the autonomous denial corresponding to the indicated amount of the sub-frame is not applied.

The autonomous denial pattern configuration may include information indicating a valid interval of the autonomous denial pattern. The valid interval of the autonomous denial pattern may be expressed by one of the number of sub-frames, the number of radio frames, and the number of system frame numbers and a combination thereof. For example, when the valid interval of the autonomous denial pattern is signaled as N radio frames, the terminal may consider that the autonomous denial pattern is valid from a time point of received information indicating the valid interval to a lapse time of N radio frames.

Alternatively, the valid interval of the autonomous denial pattern may be expressed by the repeating number of the autonomous denial pattern. For example, when the autonomous denial pattern period is K and the repeated number is N, the terminal may consider that the autonomous denial pattern is valid from a received time point of information indicating the valid interval to lapse time of K*N sub-frames.

The autonomous denial pattern configuration provided from the network may be generated based on UE assistance information provided by the terminal. The UE assistance information may include information on an autonomous denial pattern for configuration by the terminal. The UE assistance information may include at least one of information indicating a period of a desired autonomous denial pattern, information indicating an amount of a sub-frame (e.g. the number of sub-frames or a ratio of applied sub-frame) in which application of the automatic denial is required during an autonomous denial pattern of one period, and information on a configuration of the autonomous denial pattern of one period. The UE assistance information may be included in an IDC indicator to be transmitted or may be included in another uplink message to be transmitted to the network.

The network may generate autonomous denial pattern relation information to be configured in the terminal based on desired autonomous denial pattern information by the terminal to provide an autonomous denial pattern configuration including the autonomous denial pattern relation information to the terminal. The network may generate the autonomous denial pattern relation information to be configured by receiving, correcting, and changing a desired autonomous denial pattern specified according to the UE assistance information. Further, the network may generate the autonomous denial pattern relation information to be configured regardless of a desired autonomous denial pattern specified according to the UE assistance information.

If the terminal receives the autonomous denial pattern configuration, the terminal performs an autonomous denial operation based on the received autonomous denial pattern configuration (S940).

If the autonomous denial pattern configuration includes information indicating a period of the autonomous denial pattern, the terminal may periodically perform the autonomous denial operation according to the autonomous denial pattern specified by the autonomous denial pattern configuration. The autonomous denial pattern may be set to have a length corresponding to an indicated period.

When the autonomous denial pattern configuration includes information indicating a type of each sub-frame in the autonomous denial pattern, the terminal may apply the autonomous denial or may not apply the autonomous denial according to an indicated type of the sub-frame. The terminal may determine whether or not to use a corresponding sub-frame by applying the autonomous denial to a first type of sub-frame. The terminal uses a corresponding sub-frame without applying the autonomous denial to a second type of sub-frame.

When the autonomous denial pattern configuration includes an amount of the autonomous denial sub-frame, the terminal performing the autonomous denial operation may determine whether or not to use a sub-frame to which an autonomous denial is applied corresponding to an amount of a sub-frame indicated during an internal corresponding to one period of the autonomous denial pattern or a valid interval of the autonomous denial pattern. When a maximum amount of the autonomous denial sub-frame is indicated during one period, the terminal applies the autonomous denial to a sub-frame corresponding to an amount indicated during one period to determine whether or not to use. Alternatively, if the autonomous denial is applied and is not used for uplink transmission, the terminal may not apply the autonomous denial to a sub-frame after a corresponding period. When a maximum amount of the autonomous denial sub-frame is indicated during a valid interval of the autonomous denial pattern, the autonomous denial is applied to the sub-frame by the indicated amount to determine whether or not to use. Alternatively, if the autonomous denial is applied and is not used for uplink transmission, the terminal may stop the autonomous denial operation.

When the autonomous denial pattern configuration includes information indicating a valid interval of the autonomous denial pattern, the terminal may perform the autonomous denial operation during an interval considered in which the autonomous denial pattern is valid. The autonomous denial may not be applied to a sub-frame during an interval considered in which the autonomous denial pattern is invalid.

When a configuration of the autonomous denial pattern does not include information indicating a valid interval of the autonomous denial pattern, the terminal may set valid interval of the autonomous denial pattern to a value set as default. A valid interval of the autonomous denial pattern may be set as an infinite value. A valid interval of the autonomous denial pattern may be set in the terminal as a preset specific value.

If the terminal determines to stop the autonomous denial operation, the terminal may stop the operation to report that the operation stops to the network (S950).

When a valid interval of the autonomous denial pattern elapses, the terminal may determine to stop the autonomous denial operation. If the autonomous denial is applied to the sub-frame corresponding to a mount indicated in the valid interval and/or the autonomous denial is applied so that the sub-frame is not used, the terminal may determine to stop the autonomous denial operation.

To stop the autonomous denial operation may be an operation not to apply the autonomous denial to the sub-frame. To stop the autonomous denial operation may be an operation not to apply the autonomous denial to a specific sub-frame based on the autonomous denial pattern configured by the network.

The network may configure whether report to stop the autonomous denial operation is required.

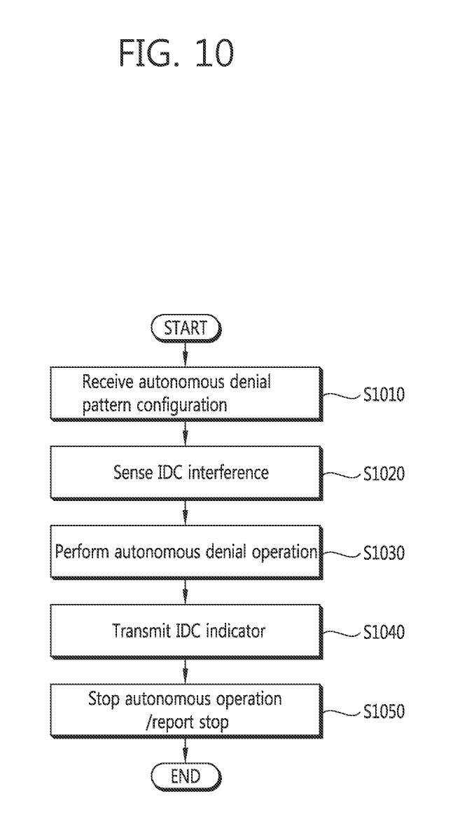

Unlike the above embodiment to acquire the autonomous denial pattern configuration as a response to the ID indicator, the terminal may acquire a configuration with respect to IDC indicator transmission together with the autonomous denial configuration upon acquisition from the network. This may refer to FIG. 10.

FIG. 10 is a flowchart illustrating an operation method based on an autonomous denial pattern configuration according to another embodiment of the present invention.

Referring to FIG. 10, a terminal acquires an autonomous denial pattern configuration (S1010). The autonomous denial pattern configuration may be transmitted together with a configuration with respect to IDC indicator transmission. The autonomous pattern configuration may be included in an RRC connection reconfiguration message to be transmitted. Autonomous denial pattern relation information included in the autonomous denial pattern configuration may be generated based on UE assistance information including desired autonomous denial pattern relation information by the terminal.

The terminal senses IDC interference (S1020). The terminal performs an autonomous denial operation corresponding to the IDC interference (S1030).

The terminal transmits the IDC indicator to the network corresponding to the sensing of the IDC interference (S1040).

Unlike the start time point of the autonomous denial operation being a received time of the autonomous denial pattern configuration in an example of FIG. 9. A start time point of the autonomous denial operation is a sensing time of the IDC interference in an example of FIG. 10. Accordingly, a valid interval of the autonomous denial pattern is an interval from a sensing time of the IDC interference to a lapse time of an indicated valid interval.

If the terminal determines to stop the autonomous denial operation, the terminal may stop the operation to report that the operation stops to the network (S1050).

When the valid interval of the autonomous denial pattern elapses, the terminal may determine to stop the autonomous denial operation. If the autonomous denial is applied to the sub-frame corresponding to a mount indicated in the valid interval and/or the autonomous denial is applied so that the sub-frame is not used, the terminal may determine to stop the autonomous denial operation.

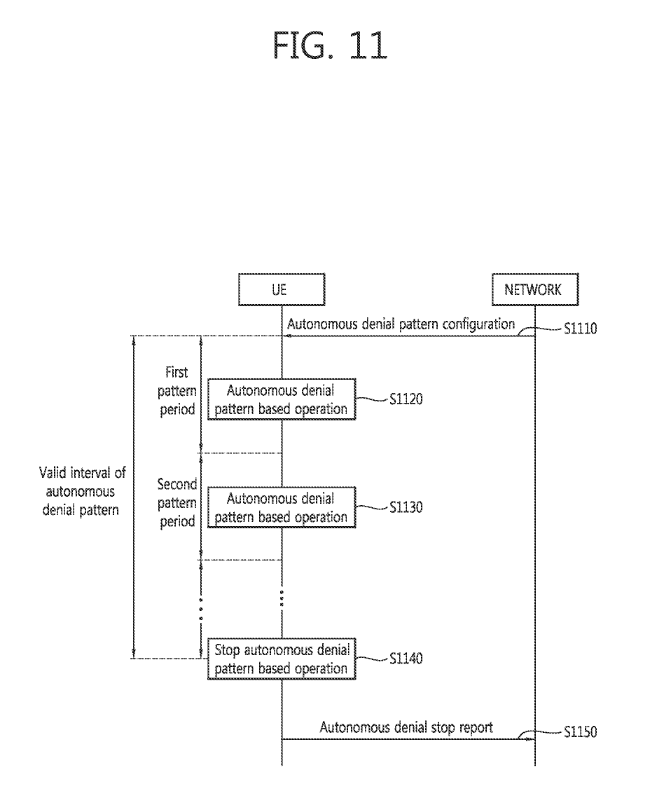

FIG. 11 is a diagram illustrating an example of an operation of a terminal based on an autonomous denial pattern configuration according to an embodiment of the present invention.

Referring to FIG. 11, the terminal receives an autonomous denial pattern configuration from a network (S1110). As described above, the autonomous denial pattern configuration may include at least one of information indicating a period of an autonomous denial pattern, information indicating a type of each sub-frame in an autonomous denial pattern of one period, information indicating an amount of a sub-frame to which the autonomous denial is applicable, and information indicating a valid interval of the autonomous denial pattern. It is assumed in the present example that an autonomous denial pattern configuration provided from the network includes information indicating a type of sub-frame, information indicating that a period of the autonomous denial pattern is a K sub-frame, and a valid interval of the autonomous denial pattern is N autonomous denial pattern periods.

If the terminal receives the autonomous denial pattern configuration, the terminal may generate/configure the autonomous denial pattern according to an indicated period. If the terminal receives the autonomous denial pattern configuration, the terminal may generate/configure the autonomous denial pattern according to the indicated period and a specific sub-frame type. In this case, the network may provide the autonomous denial pattern to the terminal through the autonomous denial pattern configuration.

If the terminal receives the autonomous denial pattern configuration, the terminal starts the autonomous denial operation based on the received autonomous denial pattern configuration.

The terminal performs the autonomous denial operation according to an autonomous denial pattern of one period during a first pattern period (S1120). The terminal may identify a sub-frame type during a first pattern period based on type indication information included in the autonomous denial pattern configuration.

The terminal may apply the autonomous denial to a first type of sub-frame. To apply the autonomous denial may include an operation where the terminal determines whether or not to use a corresponding sub-frame for uplink communication according to an autonomous denial pattern to be operated. To apply the autonomous denial may be an operation not to use a corresponding sub-frame.

The terminal may be operated without applying the autonomous denial during a second type of sub-frame. The terminal may use the second type of sub-frame for uplink communication.

The terminal receives the autonomous denial pattern configuration. After a K sub-frame elapses, the terminal performs the autonomous denial operation according to an autonomous denial pattern of one period during a second pattern period (S1130). Since an operation of the terminal during the second pattern period is the same as an operation of the terminal during the first pattern period, a detailed description thereof is omitted. Further, after the second pattern period elapses, during a valid interval of the autonomous denial pattern, the above operation may be repeated.

If the valid interval of the autonomous denial pattern is terminated, an autonomous denial pattern based operation stops (S1140). The valid period of the autonomous denial pattern may be calculated through period indication information included in the autonomous denial pattern configuration and valid internal indication information. In the present example, since an autonomous denial pattern of one period is a K sub-frame in the period indication information and an autonomous denial pattern valid interval of a total N period is set, the terminal receives the autonomous denial configuration. If a time interval corresponding to N*K sub-frames elapses, the terminal may determine that a valid period of the autonomous denial pattern is terminated.

The calculation of the valid interval of the autonomous denial pattern is illustrative purpose only. If valid interval indication information included in the autonomous denial pattern configuration directly indicates the number of specific sub-frames, the number of radio frames, or the number of SFNs, the terminal may calculate a valid interval of the autonomous denial pattern.

In step S1140, the terminal stops the autonomous denial pattern based operation when a valid interval of the autonomous denial pattern. However, when the largest amount of a sub-frame which is not used because the autonomous denial is applied is indicated, the autonomous denial pattern based operation may stop before termination of the valid interval. In this case, if the sub-frame is not used corresponding to an indicated amount, the terminal may stop the autonomous denial pattern based operation.

Further in step S1140, when a reason to operate the terminal based on the autonomous denial pattern is removed, the terminal may stop the autonomous denial pattern based operation. For example, if the terminal determines that the IDC interference is solved, the terminal may determine to stop the autonomous denial pattern based operation.

If the terminal stops the autonomous denial pattern based operation, the terminal transmit an autonomous denial stop report to the network (S1150).

According to the operation method of the present invention, the network may configure the autonomous denial pattern in the terminal. Through information included in a designated denial pattern configuration, the network may designate a sub-frame to which the autonomous denial is applied or the autonomous denial is not applied by the terminal. Accordingly, the terminal is operated without applying the autonomous denial to a specific sub-frame or may determine whether or not to use a corresponding sub-frame by applying the autonomous denial to a specific sub-frame. Since the network may ensure uplink communication by the terminal during a designated sub-frame through the autonomous denial pattern configuration, a radio resource scheduled by the network may be prevented from being consumed. In addition, since the network may configure a valid interval of the autonomous denial pattern, the terminal may be prevented from being excessively operated based on the autonomous denial pattern.

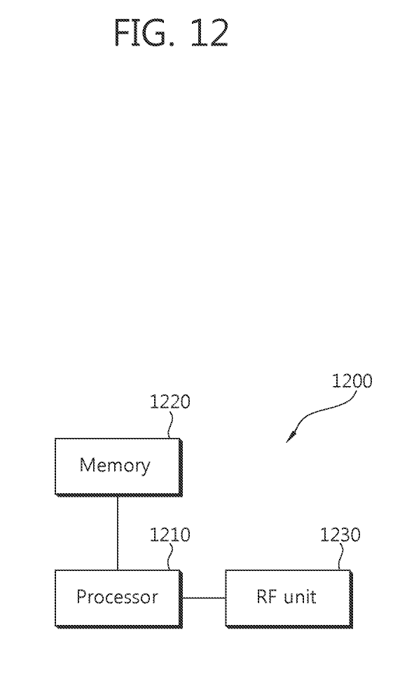

FIG. 12 is a block diagram illustrating a wireless apparatus according to an embodiment of the present invention. The wireless apparatus may implement operation of a terminal and/or a network performing the above embodiment with reference to FIGS. 9 to 11.

The wireless apparatus 1200 includes a processor 1210, a memory 1220, and a radio frequency (RF) unit 1230. The processor 1210 performs the proposed functions, processes and/or methods. The processor 1210 may request to provide configuration information associated with an autonomous denial pattern to the network. The processor 1200 may be configured to transmit the autonomous denial pattern configuration to the terminal. The processor 1200 may be configured to be operated based on an autonomous denial pattern according to the autonomous denial pattern configuration. The processor 1200 may be configured to implement the embodiment of the present invention with reference to FIG. 12.

The RF unit 1230 is connected to the processor 1210, and sends and receives radio signals.

The processor 1210 and the RF unit 1230 may be implemented to send and receive radio signals according to one or more communication standards. The RF unit 1230 may include one or more transceivers capable of sending and receiving radio signals.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. An operation method based on an autonomous denial pattern configuration by a terminal in a wireless communication system, the method comprising:
acquiring an autonomous denial pattern configuration form a network, wherein the autonomous denial pattern configuration includes autonomous denial pattern period indication information and type indication information; and
performing an autonomous denial pattern operation based on the autonomous denial pattern,
wherein the autonomous denial pattern period indication information indicates a length of the autonomous denial pattern of one period, and
the type indication information identifies the type of each sub-frame in the autonomous denial pattern of the one period.

2. The method of claim 1, wherein the performing of the autonomous denial pattern operation comprises:
identifying a type of the sub-frame based on the type indication information;
operating the terminal by applying an autonomous denial to the sub-frame when the type of the sub-frame is a first type; and
operating the terminal without applying the autonomous denial to the sub-frame when the type of the sub-frame is a second type.

3. The method of claim 2, wherein the operating the terminal without applying the autonomous denial to the sub-frame comprises using the sub-frame for uplink transmission.

4. The method of claim 3, wherein the operating the terminal by applying an autonomous denial to the sub-frame comprises determining whether to use the sub-frame for the uplink transmission based on the autonomous denial pattern.

5. The method of claim 3, wherein the operating the terminal by applying an autonomous denial to the sub-frame does not use the sub-frame for uplink transmission.

6. The method of claim 1, wherein the autonomous denial pattern configuration comprises valid interval indication information and the valid interval indication information indicates a valid interval of the autonomous denial pattern,
wherein the method further comprises stopping the autonomous denial operation when the interval indicated by the valid interval indication information elapses from acquisition of the autonomous denial pattern configuration.

7. The method of claim 6, wherein the autonomous denial pattern configuration indicates the number of repeated applications of the autonomous denial pattern.

8. The method of claim 6, further comprising transmitting a report message indicating the autonomous denial operation stop report to the network when the autonomous denial operation stops.

9. The method of claim 1, wherein the autonomous denial pattern configuration comprises information indicating the maximum number of the autonomous denial sub-frame,
the method further comprises stopping the autonomous denial operation when the sub-frame is denied from a use of uplink communication by the indicated maximum number during the autonomous denial operation.

10. The method of claim 1, further comprising:
sensing in-device coexistence (IDC) interference; and
transmitting an IDC indicator indicating the sensing to the network,
wherein the autonomous denial pattern configuration is transmitted as a response to the IDC indicator.

11. The method of claim 1, further comprising:
sensing in-device coexistence (IDC) interference; and
transmitting an IDC indicator indicating the sensing to the network,
wherein the performing of the autonomous denial operation is performed corresponding to the IDC interference.

12. The method of claim 11, further comprising receiving an IDC configuration which is configuration information associated with transmission of the IDC indicator from the network,
wherein the IDC configuration and the autonomous denial pattern configuration are simultaneously transmitted through a radio resource control (RRC) message.

13. The method of claim 1, further comprising transmitting UE assistance information to the network,
wherein the UE assistance information comprises information on a desired autonomous denial pattern from the terminal.

14. The method of claim 13, wherein the autonomous denial pattern configuration is generated based on information on the desired autonomous denial pattern transmitted from the terminal.

15. A wireless apparatus operating in a wireless communication system, the wireless apparatus comprises:
a Radio Frequency (RF) unit that sends and receives radio signals; and
a processor that is functionally coupled to the RF unit and operates,
wherein the processor is configured to:
acquire an autonomous denial pattern configuration form a network, wherein the autonomous denial pattern configuration includes autonomous denial pattern period indication information and type indication information;
perform an autonomous denial pattern operation based on the autonomous denial pattern,
wherein the autonomous denial pattern period indication information indicates a length of the autonomous denial pattern of one period, and
the type indication information identifies the type of each sub-frame in the autonomous denial pattern of the one period.
